(19) United States
(12) Patent Application Publication
(10) Pub. No.: US 2026/0136250 A1
(43) Pub. Date: May 14, 2026

(54) FREQUENCY BAND LOAD BALANCING FOR USER EQUIPMENT IDLE MODE

(71) Applicant: Verizon Patent and Licensing Inc., Basking Ridge, NJ (US)

(72) Inventors: Shuang Echo Yang, Naperville, IL (US); Susan Wu Sanders, Bridgewater, NJ (US); Xin Wang, Morris Plains, NJ (US)

(21) Appl. No.: 18/828,093

(22) Filed: Sep. 9, 2024

(51) Int. Cl. H04W 36/08; H04L 5/14; H04W 76/20; H04W 76/30

(52) U.S. Cl. CPC H04W 36/08; H04L 5/14; H04W 76/20; H04W 76/30

(57) ABSTRACT

A network device in a mobile network executes a Network Function (NF) that determines a user equipment device (UE) loading ratio among multiple frequency bands of a mobile network, and determines a first cell reselection priority, for sending to a group of first UEs transitioning to a Radio Resource Control (RRC) idle state in the mobile network, based on the determined UE loading ratio. The NF further determines a UE loading level on each frequency band of the first cell reselection priority and modifies the UE loading ratio among the multiple frequency bands based on the determined loading level. The NF determines a second cell reselection priority, for sending to a group of second UEs transitioning to the idle state in the mobile network, based on the modified UE loading ratio.

### BACKGROUND

Mobile networks, such as Next Generation mobile networks, implement Radio Resource Control (RRC) protocols for managing the network's radio resources and the states of the user equipment devices (UEs) that use those radio resources. In the Fifth Generation New Radio (5G NR, or simply 5G) mobile network, there are three primary RRC states for UEs: RRC idle, RRC connected, and RRC inactive. RRC idle state is a low-activity state that is designed to conserve UE battery life and manage UE mobility without active communication with the network. In the RRC idle state, a UE does not actively engage in data transfer but can receive system information and paging messages. RRC connected state is an active state where the UE can communicate with the network for signaling and data transfer. RRC connected state supports network control tasks, such as handovers. RRC inactive state is an intermediate state between RRC connected state and RRC idle state in which the UE suspends its connection while remaining registered with the network. RRC inactive state reduces battery consumption but enables rapid UE reactivation.

### BRIEF DESCRIPTION OF THE DRAWINGS

FIG. 1 depicts an example network environment in which frequency band load balancing may be implemented for UEs transitioning from RRC connected mode to RRC idle mode in a mobile network;

FIG. 2 depicts an example of cell clustering within a portion of a mobile network;

FIG. 3 is a diagram that depicts example components of a network device, as referred to herein;

FIGS. 4A and 4B are flow diagrams of an example process for load balancing frequency bands using idle mobility band prioritizations broadcasted in a System Information Block message;

FIG. 5 is an example diagram associated with the process of FIGS. 4A and 4B;

FIGS. 6A and 6B are flow diagrams of an example process for performing idle mode UE load balancing based upon a reconfigurable UE loading ratio among multiple frequency bands;

FIGS. 7A and 7B are example diagrams associated with the process of FIGS. 6A and 6B;

FIGS. 8A and 8B are flow diagrams of an example process for performing idle mode UE load balancing based upon a reconfigurable UE loading ratio among multiple frequency bands and further based on a service type of each UE transitioning to an RRC idle mode;

FIGS. 9A and 9B are example diagrams associated with the process of FIGS. 8A and 8B;

FIG. 10 is a flow diagram of an example process for load balancing among multiple frequency bands for use by UEs transitioning to RRC idle mode based on UE performed frequency band quality measurements;

FIG. 11 is an example diagram associated with the process of FIG. 10;

FIGS. 12A and 12B are flow diagrams of an example process for providing cell reselection priority information to UEs transitioning to RRC idle mode based on a UE loading level of the mobile network's frequency bands and further based on a service type associated with each of the UEs; and

FIGS. 13A and 13B are example diagrams associated with the process of FIGS. 12A and 12B.

### DETAILED DESCRIPTION

The following detailed description refers to the accompanying drawings. The same reference numbers in different drawings may identify the same or similar elements. The following detailed description does not limit the invention.

Mobile networks today use a wide range of radio frequency (RF) spectrum to serve ever growing wireless usages. The RF spectrum in each mobile network is typically divided into numerous different distinct frequency bands, with each band having a particular duplex mode (e.g., Time Division Duplex (TDD) mode or Frequency Division Duplex (FDD) mode), an uplink frequency range, a downlink frequency range, a possible duplex spacing, and one or more possible channel bandwidths. For example, in a Long-Term Evolution (LTE) (e.g., Fourth Generation (4G)) mobile network, band 2, named the Personal Communications Service (PCS) band, has an FDD mode, an uplink frequency range of 1850-1910 Megahertz (MHz), a downlink frequency range of 1930-1990 MHz, a duplex spacing of 80 MHz, and possible channel bandwidths of 1.4, 3, 5, 10, 15, and 20 MHz. As a further example, in the LTE mobile network, band 4, named the Advanced Wireless Service (AWS) band, has a FDD mode, an uplink frequency range of 1710-1755 MHz, a downlink frequency range of 2110-2155 MHz, a duplex spacing of 400 MHz, and possible channel bandwidths of 1.4, 3, 5, 10, 15, and 20 MHz. As another example, in a 5G mobile network, the n40 band (named the S-Band) has a TDD mode, an uplink and downlink frequency range of 2300-2400 MHz, and possible channel bandwidths of 5, 10, 15, 20, 25, 30, 40, 50, 60, 70, 80, 90, and 100 MHz. A “frequency band,” as referred to herein, may include a distinct frequency band of the mobile network (e.g., band 2 of a 4G mobile network, or band n40 of a 5G mobile network), or may include a range encompassing multiple distinct frequency bands. For example, the range encompassing multiple distinct frequency bands may include a “TDD mid-band” that encompasses multiple frequency bands having a TDD mode and uplink and downlink frequency ranges between, for example, 1 and 6 GigaHertz (GHz). As another example, the range may include a “FDD Sub 1 GHz band” that encompasses multiple frequency bands having a FDD mode and uplink and downlink frequency ranges that are less than 1 GHz. As a further example, the range may include a “FDD 1 GHz+band” having a FDD mode and uplink and downlink frequency ranges greater than, or equal to, 1 GHz. Therefore, cell reselection priority lists, as described further herein, may prioritize distinct frequency bands of the mobile network (e.g., band n40 of a 5G mobile network) and/or ranges of multiple distinct frequency bands (e.g., TDD mid-band, FDD Sub 1 GHz band, FDD 1 GHz+band).

Different frequency bands of a mobile network have different patterns of UE loading over time, ranging from light UE loading to excessive UE loading. To effectively utilize the RF spectrum in a mobile network, it is a desirable strategy to balance UE loading among different frequency bands. UE load balancing may occur based on the particular RRC mode of each UE, such as UE idle mode or UE connected mode. Idle mode balancing distributes UEs, while those UEs are transitioning to RRC idle mode, among different frequency bands.

Cell reselection is a mechanism used, in mobile networks, to deal with UE mobility when the mobile UE is in, or is transitioning to, RRC idle or RRC inactive states. When using a cell reselection mechanism, a UE, by itself, determines and selects a best cell and frequency band to “camp on”, while in an RRC idle state, based on cell reselection information supplied by the mobile network via either a System Information Block (SIB) broadcast by the mobile network or via cell reselection information supplied to the UE in an RRC Release message as the UE is transitioning from an RRC active state to the RRC idle state. The SIB broadcast may include an idle mobility band prioritization that further includes a prioritized list of cells and frequency bands within the cells that the UE should attempt to establish a connection with when the UE returns to the RRC active state from the RRC idle state. The RRC Release message may include cell reselection priority information that also includes a prioritized list of cells and frequency bands within the cells that the UE should attempt to establish a connection with when the UE switches from the RRC idle state to the RRC active state. Multiple different techniques are described herein for implementing UE load balancing among mobile network frequency bands for UEs that are transitioning to an RRC idle mode using either cell reselection information sent by the mobile network in SIB broadcasts, or sent in RRC Release messages that move the UE from an RRC active state to an RRC idle state.

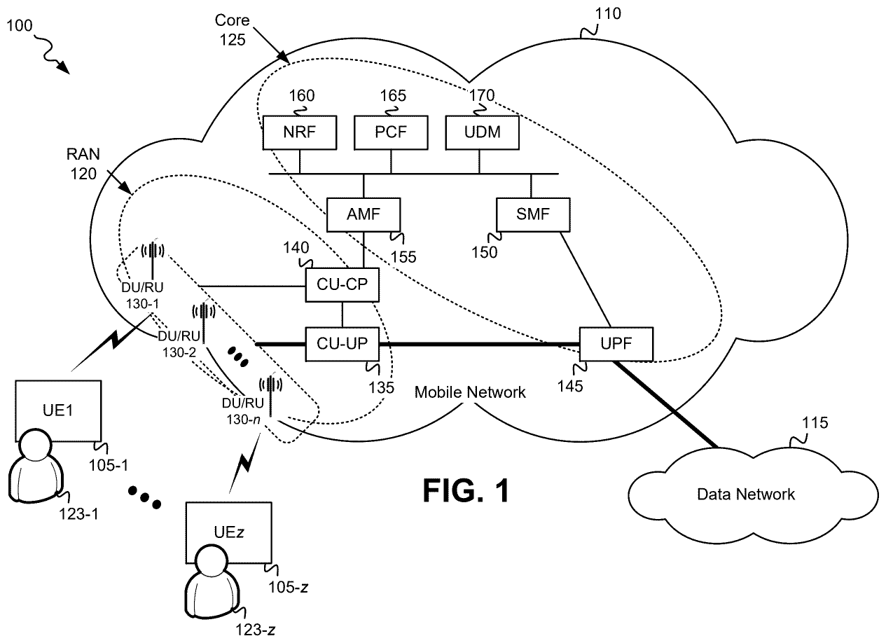

FIG. 1 depicts an example network environment 100 in which frequency band load balancing, as described further herein, may be implemented for UEs transitioning from RRC connected mode to RRC idle mode in a mobile network 100. As shown, network environment 100 includes UEs 105-1 through 105-z, a mobile network 110, and a data network 115. UEs 105-1 through 105-z (referred to herein as “UE 105” or “UEs 105”) may each include any type of electronic device having a wireless communication capability. Though only two UEs 105 are shown, network environment 100 may include numerous UEs (e.g., z>>2). UE 105 may include, for example, a laptop, palmtop, desktop, or tablet computer; a cellular phone (e.g., a “smart” phone); a Voice over Internet Protocol (VOIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (also referred to herein as a “subscriber”) may carry, use, administer, and/or operate each UE 105. For example, as shown, a first user 123-1 may operate UE 105-1 and a second user 123-z may operate UE 105-z.

Mobile network 110 (also referred to herein as “wireless network 110” or “network 110”) may include any type of a Public Land Mobile Network (PLMN). In some implementations, mobile network 110 may include any type of a Next Generation mobile network that may include evolved network components (e.g., future generation components) relative to an LTE network, such as a 4G or 4.5G mobile network. For example, mobile network 110 may include a 5G mobile network. Mobile network 110 may alternatively include another type of Next Generation network, other than the 5G network shown in FIG. 1, such as, for example, a Sixth Generation (6G) mobile network. Furthermore, although mobile network 110 is depicted in FIG. 1 as a 5G network having 5G network components/functions, mobile network 110 may additionally or alternatively include a 4G or 4.5G network with corresponding network components/functions, or a hybrid Next Generation/4G network that includes certain components of both a Next Generation network (e.g., a 5G network) and a 4G network.

As shown, mobile network 110 may include sub-networks, such as a Radio Access Network (RAN) 120 and a mobile core network 125. RAN 120 may include various types of radio access equipment that enable RF communication with UEs 105. The radio access equipment of RAN 120 may include, for example, multiple Distributed Units and Radio Units (DUs/RUs 130-1 through 130-n), and at least one Control Unit-User Plane function (CU-UP) 135 and at least one Control Unit-Control Plane (CU-CP) function 140. Additionally, or alternatively, RAN 120 may include non-split or integrated RAN devices, such as a Next Generation NodeB (gNB) or Evolved NodeB (eNB). Only a single one of CU-UP 135 and CU-CP 140 is shown in FIG. 1, however, RAN 120 may include multiple CU-CPs 140 and CU-UPs 135. In some implementations, each CU-CP 140 and CU-UP 135 may be associated with one or more clusters of cells within RAN 120 of mobile network 110. For example, a particular CU-CP 140 may control and manage the operation of DUs and RUs residing within one or more clusters of cells, and a corresponding CU-UP 135 may manage and handle user plane traffic that originates from, or is destined to, the DUs and RUs residing within the one or more clusters of cells. The CU-UP 135, among other functions, routes outgoing traffic (e.g., from a UE 105, to a DU/RU 130, and to CU-UP 135) to a UPF 145 and routes incoming traffic to a DU/RU 130 that serves the traffic's destination UE 105.

Each DU of a DU/RU 130 includes a logical node that hosts functions associated with the Radio Link Control (RLC) layer, the Medium Access Control (MAC) layer, and the physical layer (PHY). Each DU further performs centralized processing and coordination of one or more RUs, handles tasks such as scheduling and overall control of the radio resources, and interfaces with core network functions (NFs) to establish and manage connections with UEs 105 and to facilitate communication between different cells.

The RUs of a DU/RU 130 may be located at certain geographic positions within mobile network 110, and operate as radio function units that transmit and receive RF signals to/from UEs 105. Each of the RUs may include at least one antenna array, transceiver circuitry, and other hardware and software components for enabling the RUs to receive data via wireless RF signals from UEs 105, and to transmit wireless RF signals to UEs 105. Each RU may connect to a respective DU.

CU-UP 135 may interconnect with one or more DUs of RAN 120 via fronthaul links or a fronthaul network, and may include a logical node that hosts user plane functions, such as, for example, data routing and transport functions. CU-CP 140 includes a logical node that hosts Radio Resource Control (RRC), and other control plane, functions (e.g., Service Data Adaptation Protocol (SDAP), Packet Data Convergence Protocol (PDCP)) for the CU-UP 140 and for the DUs/RUs 130 that it controls. RAN 120 may additionally include other nodes, functions, and/or components not shown in FIG. 1.

Core network 125 includes devices or nodes that host and execute NFs that operate the mobile network 110 including, among other NFs, mobile network access management, session management, and policy control NFs. In the example network environment 100 of FIG. 1, core network 125 is shown as including 5G NFs, such as a User Plane Function (UPF) 145, a Session Management Function (SMF) 150, an Access and Mobility Management Function (AMF) 155, a Network Repository Function (NRF) 160, a Policy Control Function (PCF) 165, and a Unified Data Management (UDM) function 170. Each of UPF 145, SMF 150, AMF 155, NRF 160, PCF 165, and UDM 170 may be implemented as a Virtual Network Function (VNF) or a Cloud-Native Network Function (CNF) (e.g., at a data center(s)) or as a Physical Network Function (PNF) within mobile network 110.

UPF 145 may act as a router and a gateway between mobile network 110 and data network 115, and forwards session data between data network 115 and RAN 120. Though only a single UPF 145 is shown in FIG. 1, mobile network 110 may include multiple UPFs 145 at various locations in mobile network 110. SMF 150 performs session management and selects and controls UPFs 145 for data transfer. AMF 155 performs mobility management for the UEs 105.

NRF 160 operates as a centralized repository of information regarding NFs in mobile network 110. NRF 160 enables NFs (e.g., UPF 145, SMF 150, AMF 155, PCF 165, UDM 170) to register and discover each other via an Application Programming interface (API). NRF 160 maintains an updated repository of information about the NFs available in mobile network 110, along with information about the services provided by each of the NFs. NRF 160 further enables the NFs to obtain updated status information of other NFs in mobile network 110. NRF 160 may, for example, maintain profiles of available NF instances and their supported services, allow NF instances to discover other NF instances in mobile network 110, and allow NF instances to track the status of other NF instances.

PCF 165 may provide policy rules for control plane functions (e.g., for network slicing, roaming, and/or mobility management) and may access user subscription information for policy decisions. UDM 170 manages data for user access authorization, user registration, and data network profiles. UDM 170 may include, or operate in conjunction with, a User Data Repository (UDR—not shown) which stores user data, such as customer/subscriber profile information, customer/subscriber authentication information, user-subscribed network slice information, and encryption keys.

Data network 115 may include one or more interconnected networks, such as local area networks (LANs), wide area networks (WANs), metropolitan area networks (MANs), Public Switched Telephone Networks (PSTNs), Multi-Access Edge Computing networks (MECs), and/or the Internet. Data network 115 may, for example, connect with UPFs 145 of mobile network 110.

The configuration of network components of the example mobile network 110 of FIG. 1 is for illustrative purposes. Other configurations may be implemented. Therefore, mobile network 110 may include additional, fewer, and/or different components that may be configured in a different arrangement than that depicted in FIG. 1. For example, core network 125 may include other NFs not shown in FIG. 1. Additionally, though only a single instance of each of the NFs (e.g., UPF 145, SMF 150, AMF 155, NRF 160, PCF 165, UDM 170) is shown in FIG. 1, mobile network 110 may include multiple instances of each of the NFs. When implemented as VNFs or CNFs, each of the NFs described above may be installed in, and executed by, a network device residing in mobile network 110, or in another network (e.g., in an edge or a far edge network, not shown). A single network device may host and execute one or more of the NFs described above, and mobile network 110 may include at least one network device, or may have multiple (e.g., numerous) network devices that each host and execute one or more of the NFs described above.

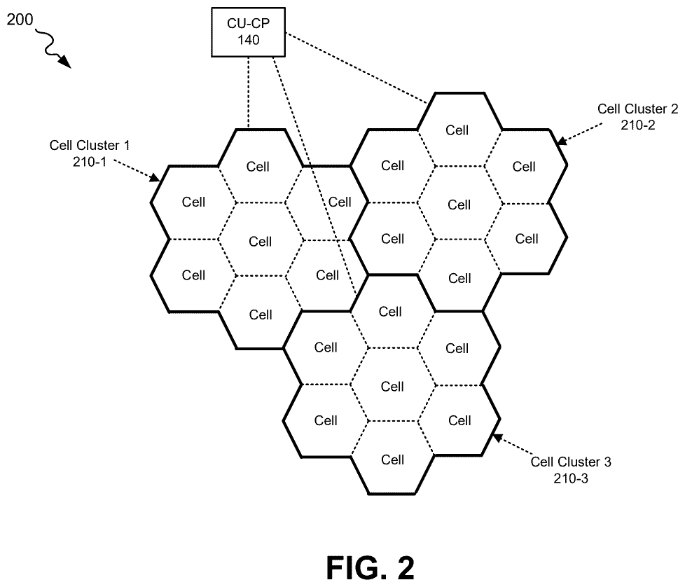

FIG. 2 depicts an example of cell clustering within a portion 200 of mobile network 110. As shown, the portion 200 of mobile network 110 includes contiguous cell clusters 210-1, 210-2, and 210-3, with each of the cell clusters including multiple contiguous cells. The use and re-use of particular frequency bands within mobile network 110 may be planned across multiple cells within a cell cluster to avoid having neighboring cells re-using a same frequency band such as to cause signal interference that degrades performance within the cells. Therefore, frequency bands are assigned to designated cells within a cell cluster such that a first frequency band used within a first cell does not interfere with a second frequency band used within a second cell that neighbors the first cell. The choice of the size of the cell cluster 210 determines a distance between cells that are using the same frequency bands. Given that each cell cluster is designed with a frequency band re-use plan that minimizes interference among neighboring cells, a given cell cluster may be replicated as multiple contiguous cell clusters (cell clusters 210-1 through 210-3 shown in FIG. 2) across at least a region of the mobile network 110. Each cell within a cell cluster 210 may use one or more frequency bands that do not interfere with the one or more frequency bands used within each of the contiguous neighboring cells.

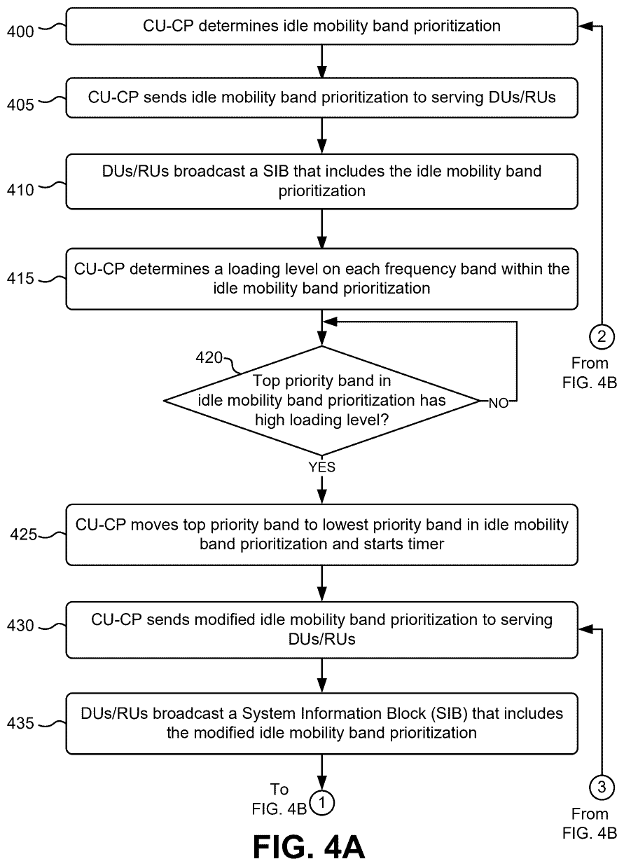

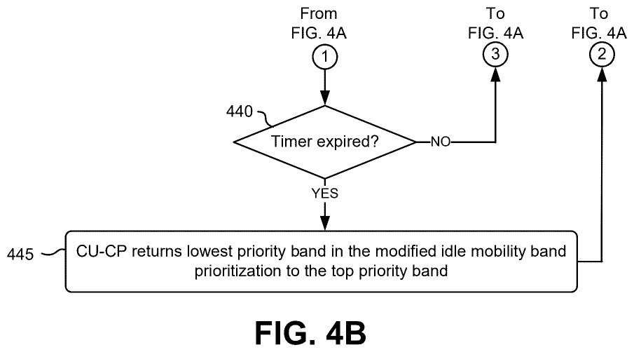

As further shown in the example of FIG. 2, a CU-CP 140 may control and manage the operation of DUs and RUs (not shown) residing within cell clusters 210-1 through 210-3. CU-CP 140 includes a logical node that hosts control plane functions for cell clusters 210-1 through 210-3, including RRC functions, and other control plane functions. CU-CP 140 may perform frequency band load balancing, as described further herein with respect to FIGS. 4A-13B, for UEs 105 transitioning to RRC idle mode, in coordination with DUs/RUs within the cell cluster(s) 210 that it controls and manages.

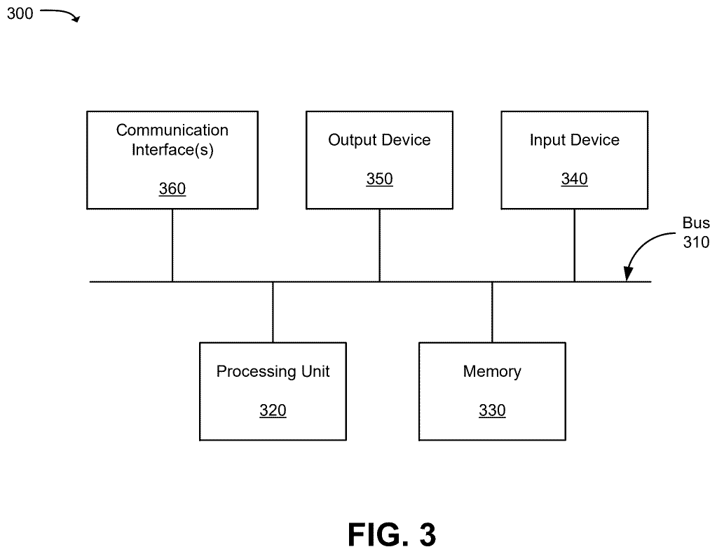

FIG. 3 is a diagram that depicts example components of a network device 300 (referred to herein as a “network device” or a “device”). UEs 105, the DUs and/or RUs of DUs/RUs 130, CU-UP 135, and CU-CP 140 may each include components that are the same as, or similar to, those of device 300 shown in FIG. 3. Furthermore, each of the NFs in mobile network 110 (e.g., UPF 145, SMF 150 AMF 155, NRF 160, PCF 165, and/or UDM 170) may be implemented by a device that includes components that are the same as, or similar to, those of network device 300. Some of the NFs of mobile network 110 may be implemented by a same device 300 within mobile network 110, while others of the functions may be implemented by one or more separate devices 300 within mobile network 110.

Device 300 may include a bus 310, a processing unit 320, a memory 330, an input device 340, an output device 350, and a communication interface 360. Bus 310 may include a path that permits communication among the components of device 300. Processing unit 320 may include one or more processors or microprocessors which may interpret and execute instructions, or processing logic. Memory 330 may include one or more memory devices for storing data and instructions. Memory 330 may include a random access memory (RAM) or another type of dynamic storage device that may store information and instructions for execution by processing unit 320, a Read Only Memory (ROM) device or another type of static storage device that may store static information and instructions for use by processing unit 320, and/or a magnetic, optical, or flash memory recording and storage medium. The memory devices of memory 330 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 330 for execution by processing unit 320.

Input device 340 may include one or more mechanisms that permit an operator to input information into device 300, such as, for example, a keypad or a keyboard, a display with a touch sensitive panel, voice recognition and/or biometric mechanisms, etc. Output device 350 may include one or more mechanisms that output information to the operator, including a display, a speaker, etc. Input device 340 and output device 350 may, in some implementations, be implemented as a user interface (UI) that displays UI information and which receives user input via the UI. Communication interface 360 may include a transceiver(s) that enables device 300 to communicate with other devices and/or systems. For example, communication interface 360 may include one or more wired and/or wireless transceivers for communicating via mobile network 110 and/or data network 115. In the case of RUs of DUs/RUs 130, communication interface 360 may further include one or more antenna arrays for producing radio frequency (RF) cells or cell sectors.

The configuration of components of network device 300 illustrated in FIG. 3 is for illustrative purposes. Other configurations may be implemented. Therefore, network device 300 may include additional, fewer and/or different components, that may be arranged in a different configuration, than depicted in FIG. 3.

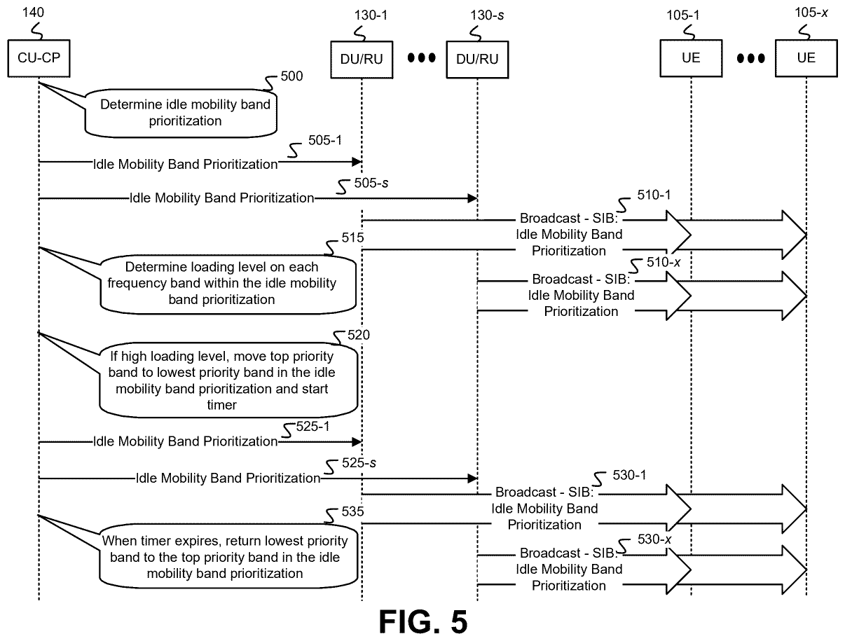

FIGS. 4A and 4B are flow diagrams of an example process for load balancing frequency bands using idle mobility band prioritizations broadcasted in a System Information Block (SIB) message. The example process of FIGS. 4A and 4B may be implemented by a CU-CP 140 in conjunction with DUs/RUs 130 of mobile network 110. The process of FIGS. 4A and 4B is described with additional reference to the example diagram of FIG. 5.

The example process includes CU-CP 140 determining an idle mobility band prioritization (block 400). The idle mobility band prioritization may include a prioritized list of frequency bands for use by UEs 105 when each of the UEs 105 transitions from RRC connected mode to RRC idle mode. For example, the idle mobility band prioritization may include the following prioritized list: freq_band_1, freq_band_2, . . . , freq_band_t, where t is any integer greater than or equal to one, and with the first listed frequency band being the highest priority band, and the last listed frequency band being the lowest priority band. In the example diagram of FIG. 5, CU-CP 140 is shown as determining 500 an idle mobility band prioritization.

CU-CP 140 sends the determined idle mobility band prioritization(s) to serving DUs/RUs 130 of RAN 120 (block 405), and the serving DUs/RUs 130 broadcast a System Information Block (SIB) that includes the idle mobility band prioritization (block 410). Upon receipt of the idle mobility band prioritization from CU-CP 140, the SIB is broadcast via a mobile network channel (e.g., the Downlink Shared Channel (DL-SCH) channel) from each of the serving DUs/RUs to UEs 105 within one or more respective cells or cell clusters. Each of the UEs 105, upon receiving the broadcasted SIB, extracts the idle mobility band prioritization and uses the prioritized list of frequency bands to determine which frequency band to “camp on” in a particular cell when transitioning to an RRC idle state. FIG. 5 depicts CU-CP 140 sending a message 505-1, with an idle mobility band prioritization, to DU/RU 130-1, and a message 505-s, with an idle mobility band prioritization, to DU/RU 130-s. FIG. 5 further shows DU/RU 130-1 broadcasting a SIB 510-1 to UE 105-1 that includes the idle mobility band prioritization, and DU/RU 130-s broadcasting a SIB 510-x to a UE 105-x that includes the idle mobility band prioritization.

CU-CP 140 determines a loading level on each frequency band within the idle mobility band prioritization (block 415). For each frequency band in the list of prioritized frequency bands contained in the idle mobility band prioritization, CU-CP 140 determines how many UEs 105 are currently loading that frequency band, and, therefore, determines a cumulative UE loading on each frequency band, for all of the frequency bands contained in the idle mobility band prioritization.

If a top priority band in the idle mobility band prioritization has a high loading level (YES-block 420), then CU-CP 140 moves the top priority band to a lowest priority band in the idle mobility band prioritization and starts a timer (block 425). If the top priority band in the idle mobility band prioritization does not have a high loading level (NO-block 420), then block 420 repeats. In one implementation, a maximum UE loading level may be set as a threshold for determining whether a particular frequency band has a high loading level. For example, a UE loading level of ten or more UEs on a frequency band may be considered a high loading level. The maximum UE loading threshold level may be the same across multiple frequency bands, or may vary by frequency band. In one example in which the idle mobility band prioritization includes the frequency bands freq_band_1, freq_band_2, and freq_band_3 (listed from highest priority to lowest priority), then if freq_band_1 has a high loading level, freq_band_1 is moved to a lowest priority band as follows: freq_band_2, freq_band_3, freq_band_1. The example of FIG. 5 illustrates CU-CP 140 determining 515 a loading level on each frequency band within the idle mobility band prioritization, and if there is a high loading level on one or more of the frequency bands of the idle mobility band prioritization, moving 520 the top priority band to the lowest priority band in the idle mobility band prioritization and starting the timer.

CU-CP 140 sends the modified idle mobility band prioritization to serving DUs/RUs 130 (block 430), and the DUs/RUs 130 broadcast a SIB that includes the modified idle mobility band prioritization (block 435). Upon receipt of the modified idle mobility band prioritization from CU-CP 140, the SIB is broadcast via a mobile network channel (e.g., the DL-SCH channel) from each of the serving DUs/RUs to UEs 105 within one or more respective cells or cell clusters. Each of the UEs 105, upon receiving the broadcasted SIB, extracts the modified idle mobility band prioritization and uses the modified, prioritized list of frequency bands to determine which frequency band to “camp on” in a particular cell when transitioning to an RRC idle state. FIG. 5 depicts CU-CP 140 sending a message 525-1, with the modified idle mobility band prioritization, to DU/RU 130-1, and a message 525-s, with the modified idle mobility band prioritization, to DU/RU 130-s. FIG. 5 further shows DU/RU 130-1 broadcasting a SIB 530-1 to UE 105-1 that includes the modified idle mobility band prioritization, and DU/RU 130-s broadcasting a SIB 530-x to a UE 105-x that includes the idle mobility band prioritization.

CU-CP 140 determines whether the timer has expired (block 440). If the timer has not expired (NO—block 440), then a portion of the example process repeats at blocks 430 and 435 until the timer expires. The timer may be set to a specified time period by the CU-CP 140, such that the modified idle mobility band prioritization continues to be used by UEs 105 transiting to RRC idle mode over the duration of the specified time period. When the timer expires (YES—block 440), then CU-CP 140 returns the lowest priority band in the modified idle mobility band prioritization to the top priority band (block 445) and the example process returns to block 400 with CU-CP 140 re-executing idle mobility band prioritization determination, and re-broadcasting the newly determined idle mobility band prioritization via a SIB. Returning to the previous example in which freq_band_1 had been moved to the lowest priority band in the modified mobility band prioritization, CU-CP 140 returns freq_band_1 to the highest priority band such that the idle mobility band prioritization again includes the frequency bands, in highest to lowest priority, as follows: freq_band_1, freq_band_2, freq_band_3. The example process of FIGS. 4A and 4B may be continuously, or periodically, performed to modify the frequency bands contained in the idle mobility band prioritization list as UE loading levels change throughout the cells and/or cell clusters of the mobile network 110. The example of FIG. 5 depicts CU-CP 140 returning 535, when the timer expires, the lowest priority band from the modified idle mobility band prioritization to the top priority band (i.e., returning the idle mobility band prioritization to its state prior to its alteration based on the determined UE loading level on each frequency band).

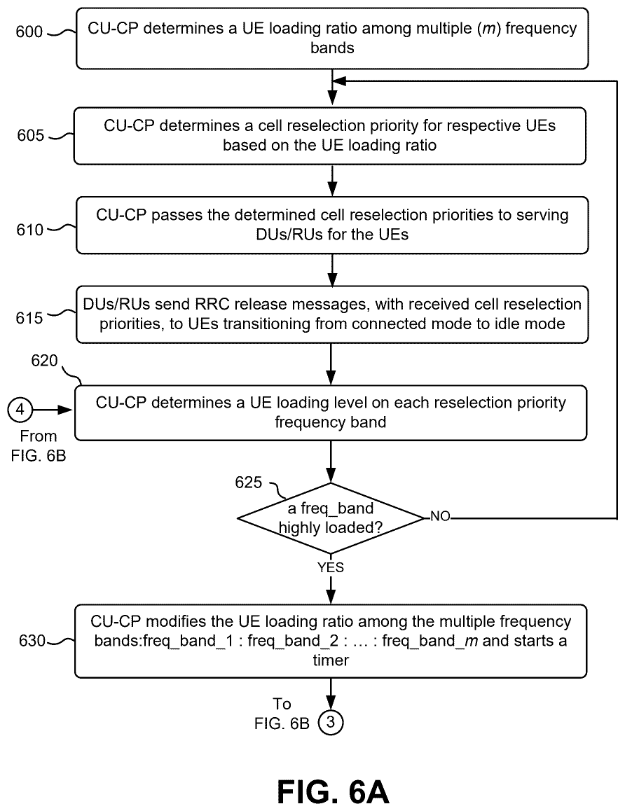

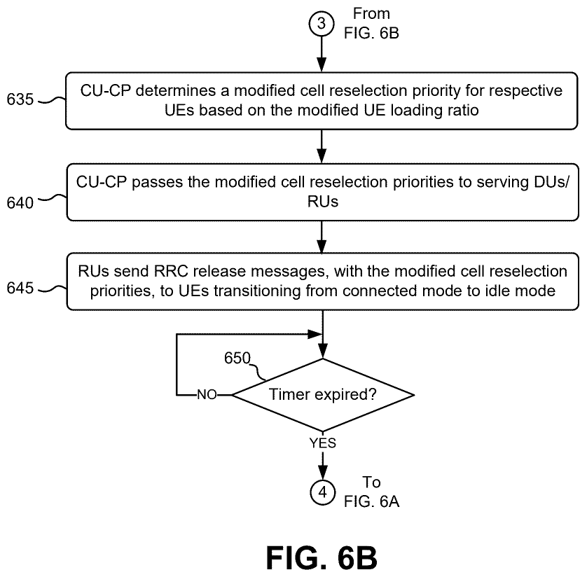

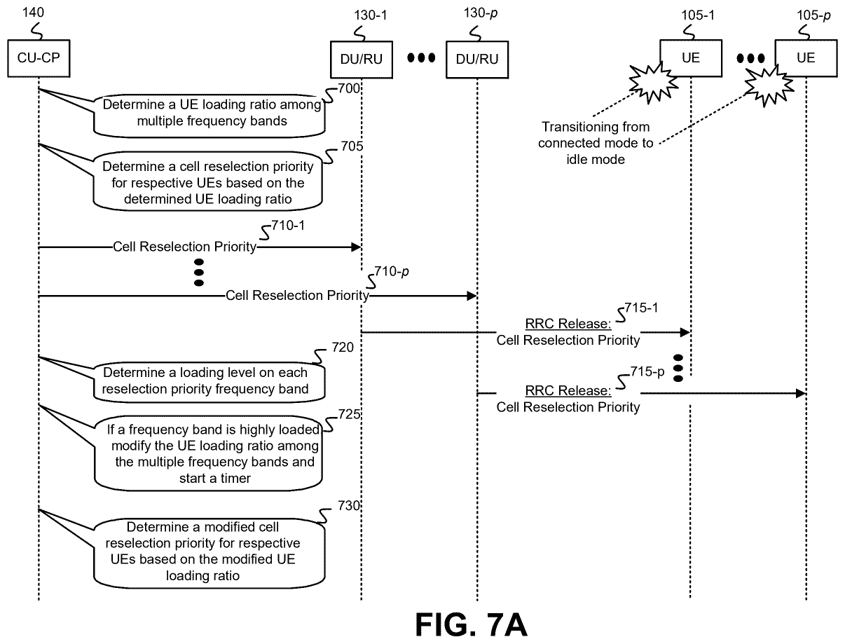

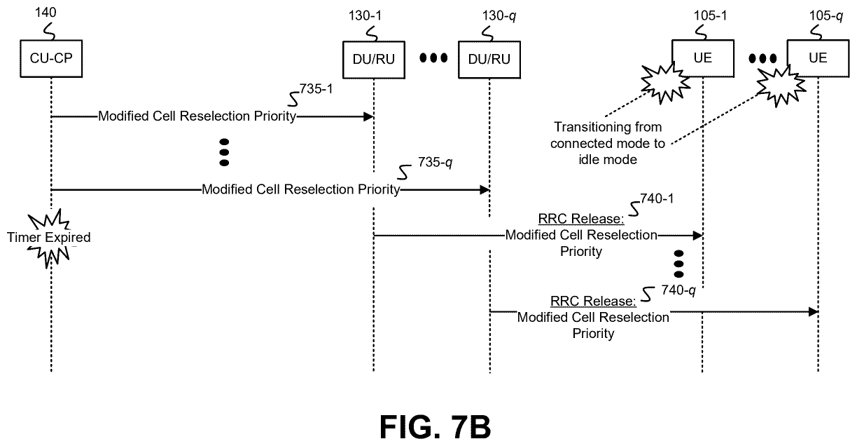

FIGS. 6A and 6B are flow diagrams of an example process for performing idle mode UE load balancing based upon a reconfigurable UE loading ratio among multiple frequency bands. The example process of FIGS. 6A and 6B may be implemented by a CU-CP 140 in conjunction with DUs/RUs 130 of mobile network 110. The example process of FIGS. 6A and 6B may be performed with respect to UEs 105 for which an RRC Release has been triggered and that are transitioning from an RRC connected mode to an RRC idle mode. The process of FIGS. 6A and 6B is described with additional reference to the example diagrams of FIGS. 7A and 7B.

The example process includes CU-CP 140 determining a UE loading ratio among multiple (m) frequency bands (where m is greater than or equal to two) (block 600). In one implementation, the frequency bands may include an entire set of m frequency bands used within one or more cell clusters that are handled by a particular CU-CP 140. For example, a group of multiple x cells of a cell cluster, that are controlled and managed by a particular CU-CP 140, may use a set of m frequency bands across all of the x cells of the cell cluster. The UE loading ratio among the m frequency bands freq_band_1, freq_band_2, . . . , freq_band_m may include the following:

$$loading\_freq \_band \_ 1 : loading\_freq \_band \_ 2 : … : loading\_freq \_band \_m \qquad Eqn . ( 1 )$$

where loading_freq_band_1 is a UE loading factor for freq_band_1 and may include integer values between 1 and 9 (i.e., 10% to 90%),
   loading_freq_band_2 is a UE loading factor for freq_band_2 and may include integer values between 1 and 9 (i.e., 10% to 90%),
   loading_freq_band_m is a UE loading factor for freq_band_m and may include integer values between 1 and 9 (i.e., 10% to 90%), and
   where the sum of the loading factors, loading_freq_band_1+loading_freq_band_2+ . . . +loading_freq_band_m equals 10 (i.e., 100%).

The UE loading ratio among the m frequency bands freq_band_1, freq_band_2, . . . , freq_band_m, therefore, specifies a relative percentage of UEs (i.e., a loading factor value of 1 equals 10% of UEs, a loading factor value of 9 equals 90% of UEs) that are to be assigned to respective frequency bands of m frequency bands, with a sum of the loading factors equaling a value of 10, or 100%. For example, with a UE loading ratio of 4:3:3 (m=3), then 40% of UEs will be assigned to freq_band_1, 30% of UEs will be assigned to freq_band_2, and 30% of UEs will be assigned to freq_band_3. In one implementation, for the UE loading ratio 4:3:3, freq_band_1 may be a TDD band, freq_band_2 may be a FDD band (in a greater than 1 GHz frequency range), and freq_band_3 may be a FDD sub 1 GHz band (in a 1 GHz or less frequency range). FIG. 7A shows CU-CP 140 determining 700 a UE loading ratio among multiple frequency bands.

CU-CP 140 determines a cell reselection priority for respective UEs 105 based on the UE loading ratio (block 605). In the one or more cell clusters over which CU-CP 140 exercises control, multiple UEs 105 may be transitioning from RRC connected mode to RRC idle mode. CU-CP 140 determines which cells in the cell clusters that the UEs are currently in, what are the neighboring cells, and what frequency bands are available in the neighboring cells, and then determines a cell reselection priority for each UE 105 based on the UE loading ratio and the available frequency bands. The cell reselection priority includes a prioritized list of frequency bands for one or more cells that neighbor a respective UE 105. For example, if 100 UEs within the one or more cell clusters are currently transitioning to RRC idle mode, and the UE loading ratio among frequency bands freq_band_1, freq_band_2, and freq_band_3 is currently specified as 4:3:3, then 40 (i.e., 40%) of the UEs (i.e., UEs having neighboring cells that support freq_band_1) will be assigned to freq_band_1, 30 (i.e., 30%) of the UEs (i.e., UEs having neighboring cells that support freq_band_2) will be assigned to freq_band_2, and 30 (i.e., 30%) of the UEs (i.e., UEs having neighboring cells that support freq_band_3) will be assigned to freq_band_3. In this example, for the 40 UEs assigned to freq_band_1, CU-CP 140 determines a cell reselection priority list, for each respective UE 105, that has freq_band_1 as the highest priority frequency band, and possibly one or more other frequency bands as lower priority frequency bands within the reselection priority list to be sent to each of the 40 UEs. For the 30 UEs assigned to freq_band_2, CU-CP 140 determines a cell reselection priority list, for each respective UE 105, that has freq_band_2 as the highest priority frequence band, and possibly one or more other frequency bands as lower priority frequency bands within the reselection priority list to be sent to each of the 30 UEs. For the 30 UEs assigned to freq_band_3, CU-CP 140 determines a cell reselection priority list, for each respective UE 105, that has freq_band_3 as the highest priority frequency band, and possibly one or more other frequency bands as lower priority frequency bands within the reselection priority list to be sent to each of the 30 UEs. The cell reselection priority list may, therefore, be customized for each UE 105 transitioning to the RRC idle mode based on the frequency bands supported by neighboring cells and based on the UE loading ratio that is specified at the CU-CP 140. FIG. 7A shows CU-CP 140 determining 705 a cell reselection priority for respective UEs 105 based on the determined loading ratio.

CU-CP 140 passes the determined cell reselection priorities to serving DUs/RUs 130 for the UEs 105 (block 610), and the DUs/RUs send RRC Release messages, with the received cell reselection priorities, to the UEs 105 transitioning from connected mode to idle mode (block 615). Each serving DU, upon receipt, from CU-CP 140, of a respective cell reselection priority destined for a particular UE 105 transitioning to RRC idle mode, generates an RRC Release message, that includes the cell reselection priority, and forwards the RRC Release message to a RU that serves the destination UE 105. The RU subsequently transmits the RRC Release message to the destination UE 105. The example diagram of FIG. 7A depicts CU-CP 140 sending a cell reselection priority 710-1 to the DU/RU 130-1 that serves UE 105-1, and a cell reselection priority 710-p to the DU/RU 130-p that serves UE 105-p. Cell reselection priority 710-1 may include a cell reselection priority list that is tailored to UE 105-1, and the neighboring cells adjacent to a current cell of UE 105-1. Cell reselection priority 710-p may include a cell reselection priority list that is tailored to UE 105-p, and the neighboring cells adjacent to a current cell of UE 105-p. As further shown in FIG. 7A, DU/RU 130-1 sends an RRC Release message 715-1, that includes the cell reselection priority, to UE 105-1 that is transitioning from an RRC connected mode to an RRC idle mode, and DU/RU 130-p sends an RRC Release message 715-p, that includes the cell reselection priority, to UE 105-p that is also transitioning from an RRC connected mode to an RRC idle mode.

CU-CP 140 determines a UE loading level on each reselection priority frequency band (block 620). CU-CP 140 determines, for each frequency band that is contained in a cell reselection priority sent to each of the UEs 105, a current UE loading level on that frequency band. For example, if frequency bands freq_band_1, freq_band_2, and freq_band_3 were contained within cell reselection priority lists sent to UEs 105 transitioning to RRC idle mode, then CU-CP 140 determines a current UE loading level on each of freq_band_1, freq_band_2, and freq_band_3, where the UE loading level includes a number of UEs currently using each frequency band for RF communication within the one or more cell clusters controlled by CU-CP 140. FIG. 7A shows CU-CP 140 determining 720 a loading level on each reselection priority frequency band.

CU-CP 140 may determine the frequency bands that have a UE loading level above a particular threshold level and may then identify those frequency bands as being highly loaded. If none of the reselection priority frequency bands is highly loaded (NO-block 625), then the example process returns to block 605, with CU-CP 140 re-determining a cell reselection priority for UEs 105 transitioning to RRC idle mode based on the existing UE loading ratio.

If at least one of the reselection priority frequency bands is highly loaded (YES-block 625), then CU-CP 140 modifies the UE loading ratio among the multiple frequency bands and starts a timer (block 630) and determines a modified cell reselection priority for respective UEs 105 based on the modified UE loading ratio (block 635). For example, for a cell reselection priority that includes frequency bands freq_band_1, freq_band_2, and freq_band_3, if freq_band_1 is identified as being highly loaded, then a current UE loading ratio may have the loading factor for freq_band_1 (loading_freq_1) reduced relative to other frequency bands in the UE loading ratio. As one particular example, if the UE loading ratio is initially 4:3:3 for frequency bands freq_band_1, freq_band_2, and freq_band_3, then the UE loading ratio may be modified to 2:4:4. CU-CP 140 determines the modified cell reselection priority for the respective UEs 105 similar to the description above with respect to block 605. The timer, once started, counts down from, for example, a pre-configured time interval until the timer reaches zero and expires. The pre-configured time interval may be a preset or default time interval, or may be dynamically adjusted based on various factors (e.g., frequency band UE loading variation over time). FIG. 7A depicts CU-CP 140 modifying 725, if a frequency band among the frequency bands of the cell reselection priority list is highly loaded, the UE loading ratio among the multiple frequency bands and starting the timer. FIG. 7A further shows CU-CP 140 determining 730 a modified cell reselection priority for respective UEs 105-1 through 105-p based on the modified UE loading ratio.

CU-CP 140 passes the modified cell reselection priorities to serving DUs/RUs 130 (block 640), and the DUs/RUs send RRC Release messages, with the modified cell reselection priorities, to UEs 105 transitioning from connected mode to idle mode (block 645). Each serving DU, upon receipt of a respective cell reselection priority destined for a particular UE 105 transitioning to RRC idle mode, generates an RRC Release message, that includes the UE 105's cell reselection priority, and forwards the RRC Release message to a RU that serves the destination UE 105. The RU subsequently transmits the RRC Release message to the destination UE 105. The example diagram of FIG. 7B depicts CU-CP 140 sending a modified cell reselection priority 735-1 to the DU/RU 130-1 that serves UE 105-1, and a modified cell reselection priority 735-q to the DU/RU 130-q that serves UE 105-q. UEs 105-1 through 105-q may be different UEs than UEs 105-1 through 105-p shown in FIG. 7A. Modified cell reselection priority 710-1 may include a modified cell reselection priority list that is tailored to UE 105-1, and the neighboring cells adjacent to a current cell of UE 105-1. Modified cell reselection priority 735-q may include a cell reselection priority list that is tailored to UE 105-q, and the neighboring cells adjacent to a current cell of UE 105-q. As further shown in FIG. 7B, DU/RU 130-1 sends an RRC Release message 715-1, that includes the cell reselection priority, to UE 105-1 that is transitioning from an RRC connected mode to an RRC idle mode, and DU/RU 130-q sends an RRC Release message 715-q, that includes the cell reselection priority, to UE 105-q that is also transitioning from an RRC connected mode to an RRC idle mode.

CU-CP 140 determines whether the timer (i.e., the timer started in block 630) has expired (block 650), and when the timer expires (YES-block 650), the example process returns to block 620 of FIG. 6A, with CU-CP 140 re-determining a UE loading level on each frequency band of the modified cell reselection priority (block 620), modifying the UE loading ratio among the multiple frequency bands if at least one of the reselection priority frequency bands is highly loaded (blocks 625 and 630), re-determining a modified cell reselection priority for respective UEs 105 based on the modified UE loading ratio (block 635), and continuing through blocks 640, 645, and 650. The timer may include a specified period of time over which CU-CP 140 waits before re-determining a new UE loading level on each reselection priority frequency band. The value of the timer may be configured by the mobile network operator, or may change dynamically based on traffic conditions within the mobile network (e.g., within the one or more cell clusters controlled by CU-CP 140).

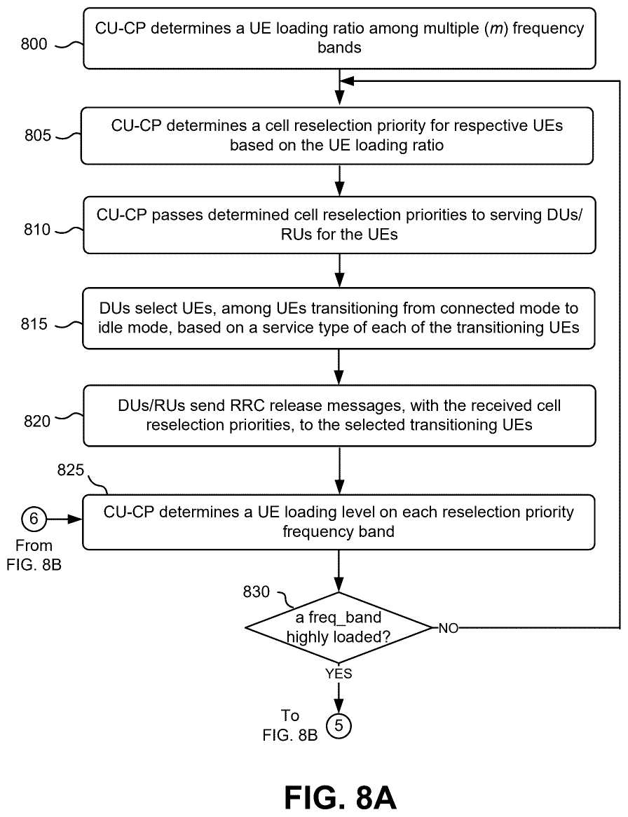

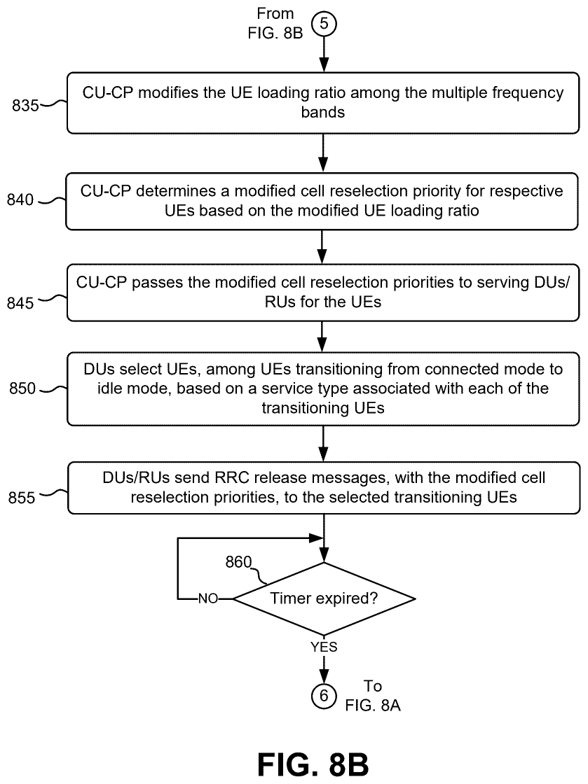

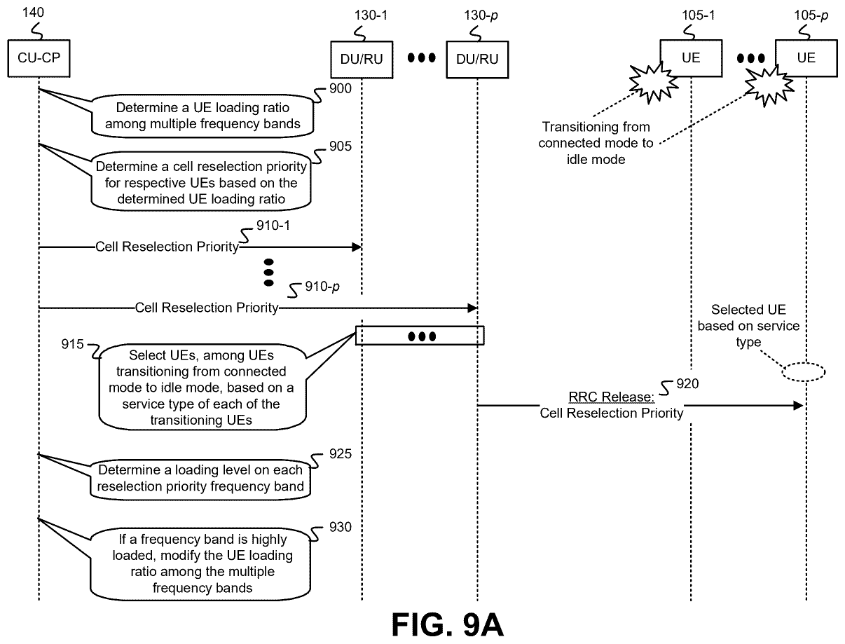

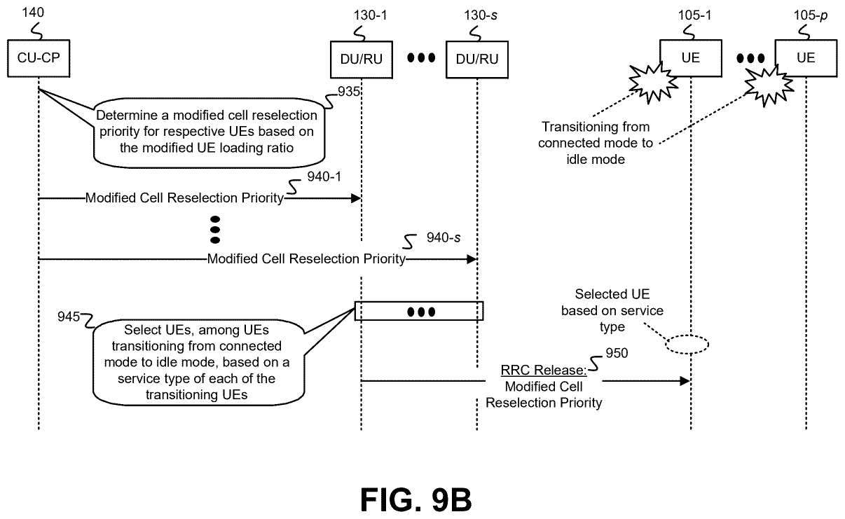

FIGS. 8A and 8B are flow diagrams of an example process for performing idle mode UE load balancing based upon a reconfigurable UE loading ratio among multiple frequency bands and further based on a service type of each UE 105 transitioning to an RRC idle mode. The example process of FIGS. 8A and 8B may be implemented by a CU-CP 140 in conjunction with DUs/RUs 130 of mobile network 110. The example process of FIGS. 8A and 8B may be performed with respect to UEs 105 for which an RRC Release has been triggered and that are transitioning from an RRC connected mode to an RRC idle mode. The process of FIGS. 8A and 8B is described with additional reference to the example diagrams of FIGS. 9A and 9B.

The example process includes CU-CP 140 determining a UE loading ratio among multiple (m) frequency bands (where m is greater than or equal to two) (block 800). In one implementation, the frequency bands may include an entire set of m frequency bands used within one or more cell clusters that are handled by a particular CU-CP 140. For example, a group of multiple x cells of a cell cluster, that are controlled and managed by a particular CU-CP 140, may use a set of m frequency bands across all of the cells of the cell cluster. As previously described, with respect to block 600 of the process of FIGS. 6A and 6B, the UE loading ratio among the m frequency bands freq_band_1, freq_band_2, . . . , freq_band_m may be represented by Eqn. (1) above. The example of FIG. 9A shows CU-CP 140 determining 900 a UE loading ratio among multiple frequency bands.

CU-CP 140 determines a cell reselection priority for respective UEs 105 based on the UE loading ratio (block 805). In the one or more cell clusters over which CU-CP 140 exercises control, multiple UEs 105 may be transitioning from RRC connected mode to RRC idle mode. CU-CP 140 determines which cells in the cell clusters that the UEs are currently in, what are the neighboring cells, and what frequency bands are available in the neighboring cells, and then determines a cell reselection priority for each UE 105 based on the UE loading ratio and the available frequency bands. The cell reselection priority includes a prioritized list of frequency bands for one or more cells that neighbor a respective UE 105. For example, if 100 UEs within the one or more cell clusters are currently transitioning to RRC idle mode, and the UE loading ratio among frequency bands freq_band_1, freq_band_2, and freq_band_3 is currently specified as 6:2:2, then 60 (i.e., 60%) of the UEs (i.e., UEs having neighboring cells that support freq_band_1) will be assigned to freq_band_1, 20 (i.e., 20%) of the UEs (i.e., UEs having neighboring cells that support freq_band_2) will be assigned to freq_band_2, and 20 (i.e., 20%) of the UEs (i.e., UEs having neighboring cells that support freq_band_3) will be assigned to freq_band_3. In this example, for the 60 UEs assigned to freq_band_1, CU-CP 140 determines a cell reselection priority list, for each respective UE 105, that has freq_band_1 as the highest priority frequency band, and possibly one or more other frequency bands as lower priority frequency bands within the reselection priority list to be sent to each of the 60 UEs. For the 20 UEs assigned to freq_band_2, CU-CP 140 determines a cell reselection priority list, for each respective UE 105, that has freq_band_2 as the highest priority frequency band, and possibly one or more other frequency bands as lower priority frequency bands within the reselection priority list to be sent to each of the 20 UEs. For the 20 UEs assigned to freq_band_3, CU-CP 140 determines a cell reselection priority list, for each respective UE 105, that has freq_band_3 as the highest priority frequency band, and possibly one or more other frequency bands as lower priority frequency bands within the reselection priority list to be sent to each of the 20 UEs. The cell reselection priority list may, therefore, be customized for each UE 105 transitioning to the RRC idle mode based on the frequency bands supported by neighboring cells and based on the UE loading ratio that is specified at the CU-CP 140. FIG. 9A shows CU-CP 140 determining 905 a cell reselection priority for respective UEs 105 based on the determined loading ratio.

CU-CP 140 passes the determined cell reselection priorities to serving DUs/RUs 130 for the UEs 105 (block 810). Each DU/RU 130 that receives a cell reselection priority selects UEs 105, among UEs 105 currently connected to the DU/RU 130 and transitioning from RRC connected mode to RRC idle mode, based on a service type of the transitioning UEs 105 (block 815). Various different service types may be differentiated by each DU/RU 130. In one example, the service types may include regular UE cellular service and a UE Fixed Wireless Access (FWA) service. Thus, UEs receiving service via FWA (e.g., via a FWA gateway) may be identified as a different service type than UEs receiving regular roaming capable service via the mobile network. FWA service employs standardized mobile network architectures and common mobile network components to deliver ultra-high-speed broadband services to fixed location residential and business subscribers, without having to lay optical fiber or cables to provide wireless broadband connectivity. In a mobile network that implements FWA, residential or business locations may use a FWA gateway (e.g., a 5G Residential Gateway (RG)) to provide a connection between the network equipment (e.g., within a home or business) and the mobile core network. The FWA gateway operates as a gateway between the mobile network and a downstream LAN, to which the residential or business located UEs connect. UEs 105 receiving service via a FWA gateway at a residential or business location are, therefore, more stationary than possibly roaming UEs 105 receiving mobile network service directly from the mobile network's RAN 120. The example of FIG. 9A depicts CU-CP 140 sending a message 910-1 to DU/RU 130-1 that includes the determined cell reselection priority, and a message 910-p to DU/RU 130-p that includes the determined cell reselection priority. Cell reselection priority 910-1 may include a cell reselection priority list that is tailored to UE 105-1, and the neighboring cells adjacent to a current cell of UE 105-1. Cell reselection priority 910-p may include a cell reselection priority list that is tailored to UE 105-p, and the neighboring cells adjacent to a current cell of UE 105-p. FIG. 9A further shows DUs/RUs 130-1 through 130-p selecting 915 UEs, among UEs transitioning from RRC connected mode to RRC idle mode, based on a service type of each of the transitioning UEs. In the example of FIG. 9A, DU/RU 130-p selects UE 105-p, that is transitioning from RRC connected mode to RRC idle mode, based on the UE 105-p's service type.

The DUs/RUs 130 send an RRC Release message(s), with the received cell reselection priority(ies), to the selected one or more UEs 105 (i.e., selected based on the UE service type in block 815) transitioning from RRC connected mode to RRC idle mode (block 820). Each serving DU of a DU/RU 130, upon selecting an idle mode transitioning UE 105 based on its service type, generates an RRC Release message, that includes the cell reselection priority, and forwards the RRC Release message to a respective RU that serves the selected UE 105. The RU subsequently transmits the RRC Release message to the selected UE 105. FIG. 9A shows DU/RU 130-p sending an RRC Release message 920, that includes a cell reselection priority, to UE 105-p that is transitioning from an RRC connected mode to an idle mode and which DU/RU 130-p selected based on UE 105-p's service type.

CU-CP 140 determines a UE loading level on each reselection priority frequency band (block 825). CU-CP 140 determines, for each frequency band that is contained in a cell reselection priority sent to each of the UEs 105, a current UE loading level on that frequency band. For example, if frequency bands freq_band_1, freq_band_2, and freq_band_3 were contained within cell reselection priority lists sent to UEs 105 transitioning to idle mode, then CU-CP 140 determines a current UE loading level on each of freq_band_1, freq_band_2, and freq_band_3, where the UE loading level includes a number of UEs currently using each frequency band for RF communication within the one or more cell clusters controlled by CU-CP 140. FIG. 9A shows CU-CP 140 determining 925 a loading level on each reselection priority frequency band.

CU-CP 140 may determine the frequency bands that have a UE loading level above a particular threshold level and may then identify those frequency bands that are highly loaded. If none of the reselection priority frequency bands is highly loaded (NO-block 830), then the example process returns to block 805, with CU-CP 140 re-determining a cell reselection priority for UEs 105 transitioning to idle mode based on the existing UE loading ratio. If at least one of the reselection priority frequency bands is highly loaded (YES-block 835), then CU-CP 140 modifies the UE loading ratio among the multiple frequency bands (block 840) and determines a modified cell reselection priority for respective UEs 105 based on the modified UE loading ratio (block 845). For example, for a cell reselection priority that includes frequency bands freq_band_1, freq_band_2, and freq_band_3, if freq_band_1 is identified as being highly loaded, then a current UE loading ratio may have the loading factor for freq_band_1 (loading_freq_1) reduced relative to other frequency bands in the UE loading ratio. As one particular example, if the UE loading ratio initially has loading factors of 6:2:2 for frequency bands freq_band_1, freq_band_2, and freq_band_3, then the UE loading ratio may be modified to the following loading factors 4:3:3. CU-CP 140 determines the modified cell reselection priority for the respective UEs 105 similar to the description above with respect to block 805. FIG. 9A depicts CU-CP 140 modifying 930, if a frequency band among the frequency bands of the cell reselection priority list is highly loaded, the UE loading ratio among the multiple frequency bands. FIG. 9B further shows CU-CP 140 determining 935 a modified cell reselection priority for respective UEs 105 based on the modified UE loading ratio.

CU-CP 140 passes the modified cell reselection priorities to serving DUs/RUs 130 (block 845). Each DU/RU 130 that receives a cell reselection priority selects UEs 105, among UEs 105 currently connected to the DU/RU 130 and transitioning from RRC connected mode to RRC idle mode, based on a service type of the transitioning UEs 105 (block 850). The differentiating of service type of each UE, by the DU/RU 130, is described above with respect to block 815. The DUs/RUs 130 send RRC Release messages, with the modified cell reselection priorities, to the selected UEs 105 (i.e., selected based on service type in block 850) transitioning from connected mode to idle mode (block 855). Each serving DU, upon receipt of a respective cell reselection priority destined for a selected UE 105 transitioning to RRC idle mode, generates an RRC Release message, that includes the selected UE 105's cell reselection priority, and forwards the RRC Release message to a RU that serves the destination UE 105. The RU subsequently transmits the RRC Release message to the destination UE 105. The example diagram of FIG. 9B depicts CU-CP 140 sending a modified cell reselection priority 940-1 to DU/RU 130-1, and a modified cell reselection priority 940-s to DU/RU 130-s. UEs 105-1 through 105-p shown in FIG. 9B may be different UEs than UEs 105-1 through 105-p shown in FIG. 9A. Modified cell reselection priority 940-1 may include a modified cell reselection priority list that is tailored to UE 105-1, and the neighboring cells adjacent to a current cell of UE 105-1. Modified cell reselection priority 940-s may include a cell reselection priority list that is tailored to UE 105-p, and the neighboring cells adjacent to a current cell of UE 105-p. As further shown in FIG. 9B, DUs/RUs 130-1 through 130-s select 945, among UEs transitioning from connected mode to idle mode, based on a service type of each of the transitioning UEs. In the particular example of FIG. 9B, DU/RU 130-1 selects UE 105-1 based on a service type of UE 105-1, and sends an RRC Release message 950, that includes the modified cell reselection priority, to UE 105-1 that is transitioning from an RRC connected mode to an idle mode. DU/RU 130-s, in the example shown, does not select any UE 105 based on UE service type and, therefore, does not send any RRC Release messages.

CU-CP 140 determines whether a timer has expired (block 860), and when the timer expires (YES-block 860), the example process returns to block 825 of FIG. 8A, with CU-CP 140 re-determining a UE loading level on each frequency band of the modified cell reselection priority (block 825), modifying the UE loading ratio among the multiple frequency bands if at least one of the reselection priority frequency bands is highly loaded (blocks 830 and 835), re-determining a modified cell reselection priority for respective UEs 105 based on the modified UE loading ratio (block 840), and continuing through blocks 845, 850, 855, and 860. The timer may include a specified period of time over which CU-CP 140 waits before re-determining a new UE loading level on each reselection priority frequency band. The value of the timer may be configured by the mobile network operator, or may change dynamically based on traffic conditions within the mobile network (e.g., within the one or more cell clusters controlled by CU-CP 140).

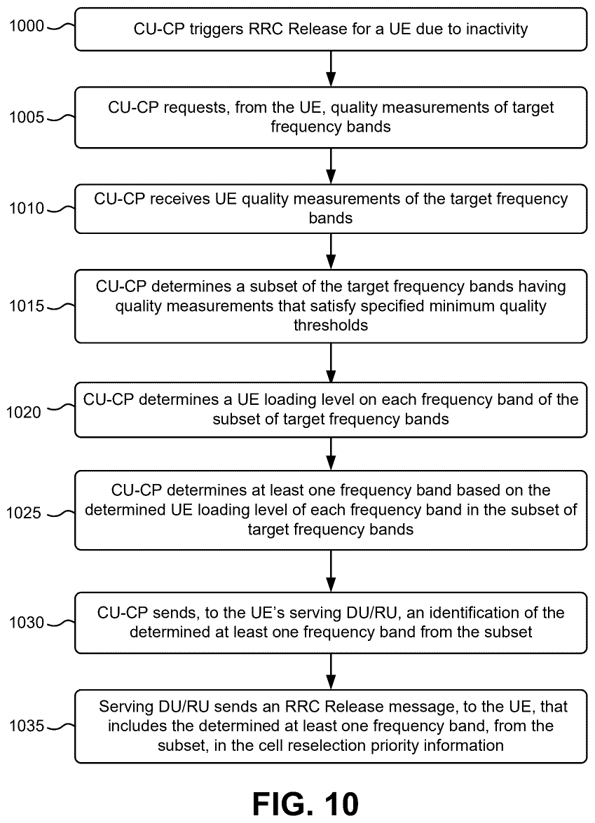

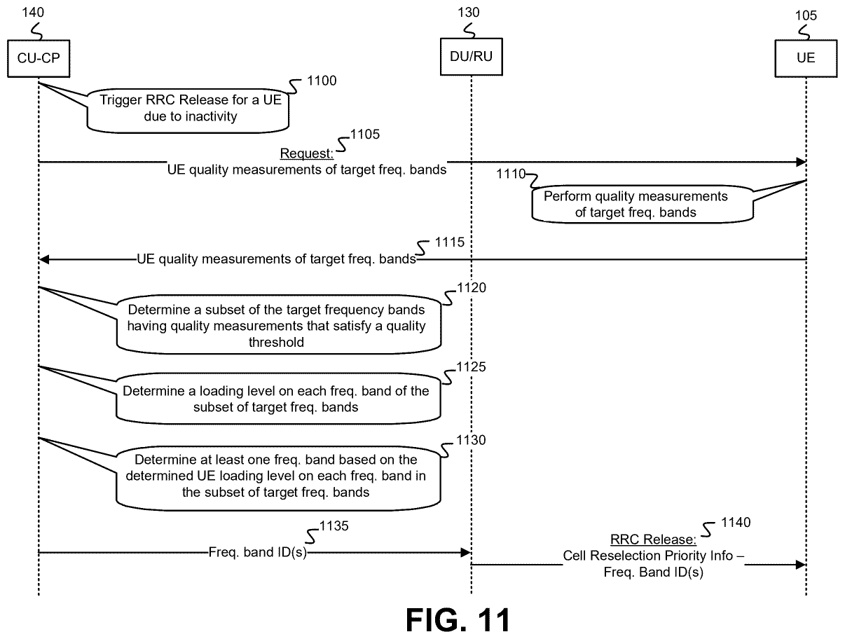

FIG. 10 is a flow diagram of an example process for load balancing among multiple frequency bands, for use by UEs 105 transitioning to RRC idle mode, based on UE-performed frequency band quality measurements. The example process of FIG. 10 may be implemented by a CU-CP 140 in conjunction with DUs/RUs 130 of mobile network 110. The example process of FIG. 10 is described with additional reference to the example diagram of FIG. 11.

The example process includes CU-CP 140 triggering an RRC Release for a UE 105 due to inactivity (block 1000). Due to communication inactivity, the UE 105 may transition from an RRC connected mode to an RRC idle mode, with CU-CP 140 triggering the RRC Release for the UE 105. Conditions other than communication inactivity may, however, be used, additionally or alternatively, for triggering the RRC Release (e.g., mobility events involving the UE 105, network optimization events, UE initiation events). CU-CP 140 may then request, from the UE 105, quality measurements of target frequency bands (block 1005), and receives, in return from the UE 105, UE-performed quality measurements of the target frequency bands (block 1010). The UE-performed quality measurements may include, for example, Received Signal Strength Indicator (RSSI) measurements, Reference Signal Received Power (RSRP) measurements, or Reference Signal Received Quality (RSRQ) measurements on each of the target frequency bands. Other signal quality measurements, not described herein, may be performed at the UE 105 and returned to the CU-CP 140 instead of, or in addition to, the RSSI, RSRP, or RSRQ measurements described above. The example diagram of FIG. 11 depicts CU-CP 140 triggering 1100 an RRC Release for UE 105 due to inactivity, and sending a Request message 1105 to the UE 105 that requests UE quality measurements of identified target frequency bands. UE 105, upon receipt of Request 1105, performs 1110 quality measurements of the target frequency bands identified in Request 1105, and then returns a message 1115 to CU-CP 140 that includes values for the UE-performed quality measurements of the target frequency bands.

CU-CP 140 determines a subset of the target frequency bands having quality measurements that satisfy specified minimum quality thresholds (block 1015). For each frequency band of the target frequency bands, CU-CP 140 compares a corresponding UE quality measurement of the frequency band with a specified minimum quality threshold. Each frequency band that meets the minimum quality threshold is retained in the subset of the target frequency bands, and each frequency band that does not meet the minimum quality threshold is omitted from the subset. As an example, the target frequency bands may include freq_band_1, freq_band_2, and freq_band_3. In this example, the minimum quality threshold is specified as −10 dB, and the measured signal qualities for freq_band_1, freq_band_2, and freq_band_3 returned from the UE 105 are +5 dB, −15 dB, and −2 dB. CU-CP 140, in this example, thus, determines that freq_band_1 and freq_band_3 have quality measurements that satisfy the minimum quality threshold of −10 dB. FIG. 11 shows CU-CP 140 determining 1120 a subset of the target frequency bands having quality measurements that satisfy a specified minimum quality threshold.

CU-CP 140 determines a UE loading level on each frequency band of the subset of target frequency bands (block 1020). For each frequency band retained in the subset, CU-CP 140 determines, as the UE loading level, a number of UEs currently using the frequency band. The example of FIG. 11 depicts CU-CP 140 determining 1125 a loading level on each frequency band of the subset of target frequency bands.

CU-CP 140 determines at least one frequency band based on the determined UE loading level of each frequency band in the subset of target frequency bands (block 1025), and sends, to the UE 105's serving DU/RU 130, an identification of the determined at least one frequency band from the subset (block 1030). CU-CP 140 compares the UE loading level for each of the frequency bands (e.g., determined in block 1020) in the subset of target frequency bands with, for example, a loading threshold. The loading threshold may specify a maximum number of UEs that may load each frequency band. If the determined UE loading level of a given target frequency band is less than the loading threshold, then the target frequency band is included as a determined frequency band. If the determined UE loading level of a given frequency band meets or exceeds the loading threshold the loading threshold, then the frequency band is excluded from the determined frequency band(s). Alternatively, if there are multiple frequency bands having UE loading levels that are less than the loading threshold, then CU-CP 140 may select less than all of the multiple frequency bands (e.g., two out of four, or three out of six that have the lowest UE loading levels) and identify the selected frequency bands as the determined frequency bands. The example of FIG. 11 depicts CU-CP 140 determining 1130 at least one frequency band based on the determined UE loading levels, and sending a message 1135, to the DU/RU 130 serving UE 105, that includes an identification(s) of the determined frequency band(s) from the subset of target frequency bands.

The UE 105's serving DU/RU 130 then sends an RRC Release message, to the UE 105, that includes the determined at least one frequency band, from the subset, in the cell reselection priority information (block 1035). Returning to the example described above, the cell reselection priority information would include a frequency band priority list that includes freq_band_1, or possibly freq_band_1 followed by freq_band_3. UE 105, upon receiving the RRC Release message, may, while in idle mode, subsequently choose to switch to, and connect with, one of the frequency bands contained in the cell reselection priority information of the RRC Release message, with the UE 105 choosing one of the frequency bands in prioritized order. FIG. 11 depicts DU/RU 130 sending an RRC Release message 1140 to UE 105 that includes the cell reselection priority information which further includes identifications of the one or more frequency bands that may be used by the UE 105, while in idle mode, for cell reselection.

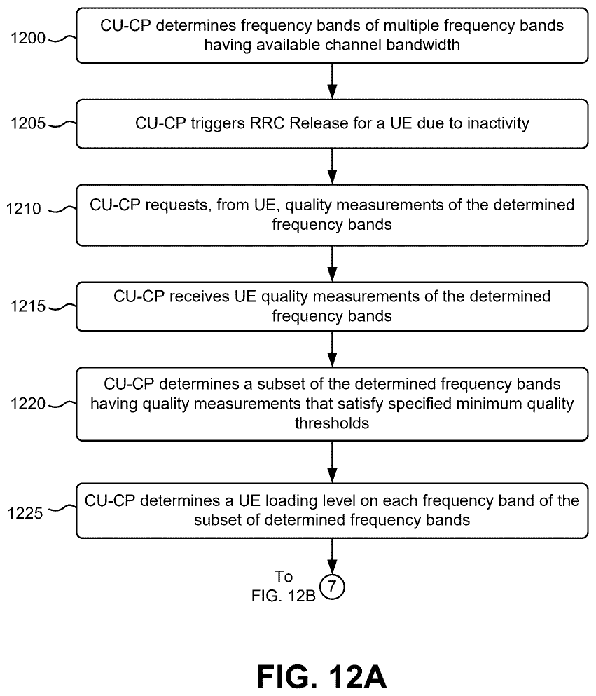

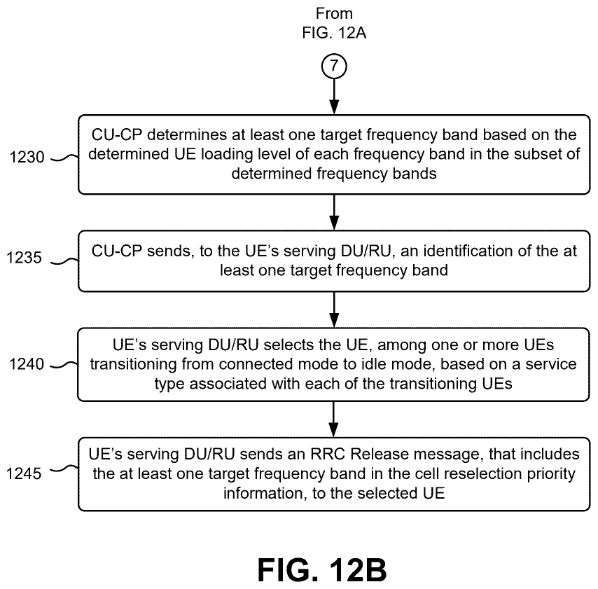

FIGS. 12A and 12B are flow diagrams of an example process for providing cell reselection priority information to UEs 105 transitioning to RRC idle mode based on a UE loading level of the mobile network 110's frequency bands and further based on a service type associated with each of the UEs 105. The example process of FIGS. 12A and 12B may be implemented by a CU-CP 140 in conjunction with DUs/RUs 130 of mobile network 110. The process of FIGS. 12A and 12B may be repeated, either whole or in part, for each UE 105 within a cell, or one or more clusters of cells, controlled by a CU-CP 140. The process of FIGS. 12A and 12B may be repeated periodically for each UE 105, or may be repeated upon an occurrence of a particular condition or event (e.g., the UE satisfies conditions for triggering an RRC Release).

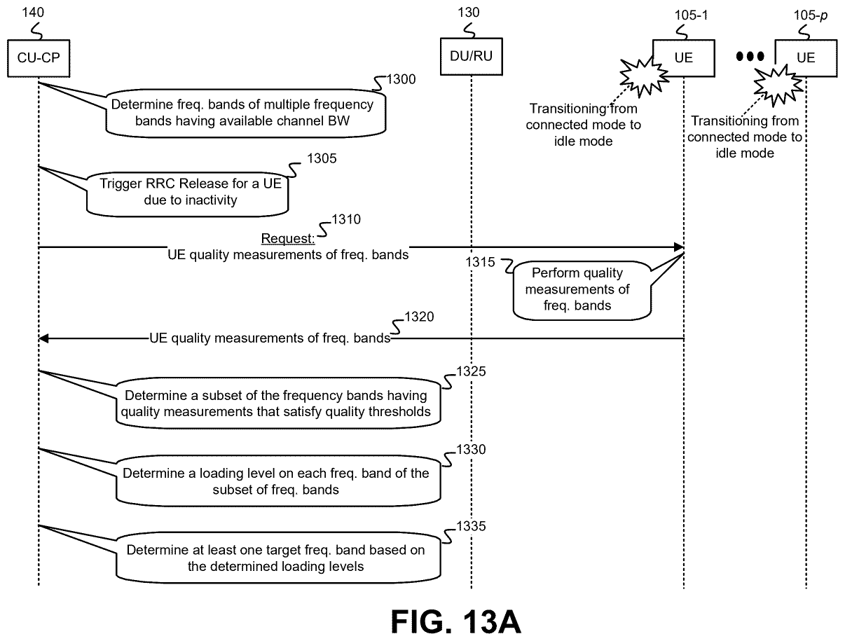

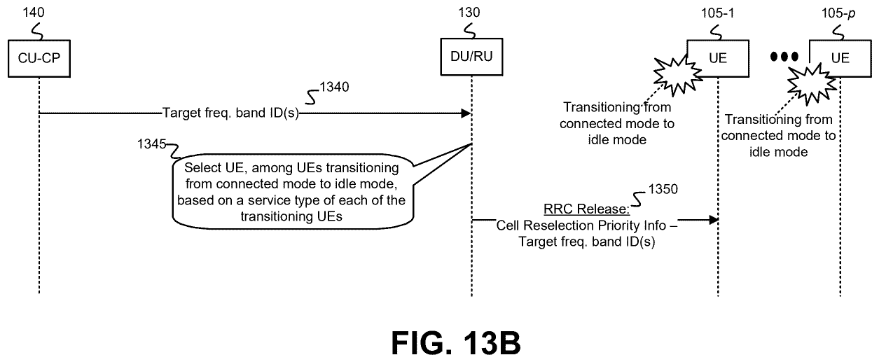

The example process includes CU-CP 140 determining frequency bands of multiple frequency bands having available channel bandwidth (block 1200). For each UE 105 within a cell, or one or more cell clusters, controlled by CU-CP 140, CU-CP 140 determines the cells that serve a current location of the UE 105, and further determines the multiple frequency bands within the cells that have available channel bandwidth. For example, in a 5G mobile network, CU-CP 140 identifies the particular frequency bands, among bands n1 to n109, that are offered by the cells that serve the current location of the UE 105, and then determines which of the identified bands has available channel bandwidth to handle traffic from the UE 105. The example of FIG. 13A depicts CU-CP 140 determining 1300 frequency bands of multiple frequency bands having available channel bandwidth (BW).

CU-CP 140 triggers an RRC Release for a UE 105 due to inactivity (block 1205), and requests, from the UE 105, quality measurements of the determined frequency bands (block 1210). CU-CP 140 may, for example, trigger an RRC Release based on a lack of communication activity involving the UE 105. Other conditions may, however, be used, additionally or alternatively, for triggering an RRC Release (e.g., mobility events involving the UE 105, network optimization events, UE initiation events). The requested quality measurements to be performed by the UE may include, for example, RSSI measurements, RSRP measurements, or RSRQ measurements on each of the determined frequency bands. Other signal quality measurements, not described herein, may be requested by CU-CP 140 from the UE 105 and returned to the CU-CP 140 instead of, or in addition to, the RSSI, RSRP, or RSRQ measurements described above. FIG. 13A shows CU-CP 140 triggering 1305 an RRC Release for a particular UE 105-1 due to inactivity, and sending a Request message 1310 to the UE 105-1 that requests UE quality measurements of the previously determined frequency bands.

CU-CP 140 receives UE quality measurements of the determined frequency bands (block 1215). As shown in the example of FIG. 13A, UE 105-1 performs 1315 quality measurements of the frequency bands identified in the receive Request message 1310, and returns a message 1320 to CU-CP 140 that includes the UE-performed quality measurements of the identified frequency bands.

CU-CP 140 determines a subset of the determined frequency bands having quality measurements that satisfy specified minimum quality thresholds (block 1220), and determines a UE loading level on each frequency band of the subset of determined frequency bands (block 1225). For each frequency band, of the determined frequency bands having available channel bandwidth, CU-CP 140 compares a corresponding UE quality measurement of the frequency band with a specified minimum quality threshold. Each frequency band that meets the minimum quality threshold is retained in the subset of the determined frequency bands, and each frequency band that does not meet the minimum quality threshold is omitted from the subset. For each frequency band retained in the subset, CU-CP 140 determines, as the UE loading level, a number of UEs currently using the frequency band. The example of FIG. 13A illustrates CU-CP 140 determining 1325 a subset of the frequency bands having quality measurements that satisfy quality thresholds and determining 1330 a loading level on each frequency band of the subset of frequency bands.

CU-CP 140 determines at least one target frequency band based on the determined loading level of each frequency band in the subset of determined frequency bands (block 1230), and sends, to the UE 105's serving DU/RU 130, an identification of the at least one target frequency band (block 1235). For each frequency band retained in the subset, CU-CP 140 determines, as the UE loading level, a number of UEs currently using the frequency band. CU-CP 140 compares the UE loading level for each of the frequency bands in the subset of determined frequency bands with, for example, a loading threshold. The loading threshold may specify a maximum number of UEs that may load each frequency band. If the determined UE loading level of a given frequency band is less than the loading threshold, then the frequency band is included as a target frequency band. If the determined UE loading level of a given frequency meets or exceeds the loading threshold the loading threshold, then the frequency band is excluded from the target frequency band(s). Alternatively, if there are multiple frequency bands having UE loading levels that are less than the loading threshold, then CU-CP 140 may select less than all of the multiple frequency bands (e.g., two out of four, or three out of six that have the lowest UE loading levels) and identify the selected frequency bands as the target frequency bands. The example of FIG. 13A depicts CU-CP 140 determining 1335 at least one target frequency band based on the determined loading levels, and FIG. 13B further depicts CU-CP 140 sending a message 1340, to the DU/RU 130 serving UE 105-1, that includes identifications of the determined target frequency bands.

The UE 105's serving DU/RU 130 selects the UE 105, among one or more UEs 105 transitioning from connected mode to idle mode, based on a service type associated with each of the transitioning UEs 105 (block 1240), and sends an RRC Release message, that includes the at least one target frequency band in the cell reselection priority information, to the selected UE 105 (block 1245). The differentiating of service type of each UE, by the DU/RU 130, is described above with respect to block 815 of the process of FIGS. 8A and 8B. Each serving DU of a DU/RU 130, upon selecting the UE 105, among one or more UEs 105 that are transitioning to RRC idle mode, based on its service type, generates an RRC Release message, that includes an identification of the at least one target frequency band in the cell reselection priority information, and forwards the RRC Release message to a respective RU that serves the selected UE 105. The RU subsequently transmits the RRC Release message to the selected UE 105. The example of FIG. 13B shows DU/RU 130 selecting 1345 UE 105-1, among other UEs 105, including UE 105-p, that are transitioning from RRC connected mode to RRC idle mode based on a service type of each of the UEs 105. FIG. 13B further shows DU/RU 130 sending na RRC Release message 1350 to the selected UE 105-1 that includes an ID of the target frequency band(s) within the cell reselection priority information of the message.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 4A, 4B, 6A, 6B, 8A, 8B, 10, 12A, and 12B, and sequences of operations, messages, and/or data flows with respect to FIGS. 5, 7A, 7B, 9A, 9B, 11, 13A, and 13B, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 320) of a device. A non-transitory storage medium includes one or more of the storage mediums described in relation to memory 330. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
determining a user equipment device (UE) loading ratio among multiple frequency bands of a mobile network;
determining a first cell reselection priority, for sending to a group of first UEs transitioning to a Radio Resource Control (RRC) idle state in the mobile network, based on the determined UE loading ratio;
determining a UE loading level on each frequency band of the first cell reselection priority;
modifying the UE loading ratio among the multiple frequency bands based on the determined loading level; and
determining a second cell reselection priority, for sending to a group of second UEs transitioning to the idle state in the mobile network, based on the modified UE loading ratio.

2. The method of claim 1, further comprising:
selecting the group of first UEs and the group of second UEs, among multiple UEs transitioning to the RRC idle state in the mobile network, based on a service type of each of the multiple UEs;
causing the first cell reselection priority to be sent to the selected group of first UEs; and
causing the second cell reselection priority to be sent to the selected group of second UEs.

3. The method of claim 2, wherein the service type comprises Fixed Wireless Access (FWA) service.

4. The method of claim 1, further comprising:
causing first Radio Resource Control (RRC) Release messages, that include the first cell reselection priority, to be sent to the group of first UEs; and
causing second RRC messages, that include the second cell reselection priority, to be sent to the group of second UEs.

5. The method of claim 1, wherein the UE loading ratio corresponds to a specified percentage of UEs transitioning to the idle state to be assigned to each of the multiple frequency bands.

6. The method of claim 1, wherein the multiple frequency bands comprise m frequency bands, freq_band_1, . . . , freq_band_m, wherein the UE loading ratio comprises m UE loading factor values, loading_freq_band_1, . . . , loading_freq_band_m that each comprises integer values between 1 and 9, and wherein a sum of the UE loading factor values loading_freq_band_1+ . . . +loading_freq_band_m equals 10.

7. The method of claim 1, wherein the multiple frequency bands comprise first frequency bands, second frequency bands, and third frequency bands, and wherein the first frequency bands comprise one or more Time Division Duplexing (TDD) bands, the second frequency bands comprise one or more Frequency Division Duplexing (FDD) bands in a first frequency range, and wherein the third frequency bands comprise one or more FDD bands in a second frequency range.

8. The method of claim 1, wherein the method is executed by a Central Unit-Control Plane (CU-CP) Network Function (NF) of a Radio Access Network (RAN) of the mobile network.

9. A network device, comprising:
at least one communication interface configured to communicate via a mobile network; and
at least one processor configured to execute a Network Function (NF) to:
determine a user equipment device (UE) loading ratio among multiple frequency bands of a mobile network;
determine a first cell reselection priority, for sending to a group of first UEs transitioning to a Radio Resource Control (RRC) idle state in the mobile network, based on the determined UE loading ratio;
determine a UE loading level on each frequency band of the first cell reselection priority;
modify the UE loading ratio among the multiple frequency bands based on the determined loading level; and
determine a second cell reselection priority, for sending to a group of second UEs transitioning to the idle state in the mobile network, based on the modified UE loading ratio.

10. The network device of claim 9, wherein the at least one processor is further configured to execute the NF to:
select the group of first UEs and the group of second UEs, among multiple UEs transitioning to the RRC idle state in the mobile network, based on a service type of each of the multiple UEs;
cause the first cell reselection priority to be sent to the selected group of first UEs; and
cause the second cell reselection priority to be sent to the selected group of second UEs.

11. The network device of claim 10, wherein the service type comprises Fixed Wireless Access (FWA) service.

12. The network device of claim 9, wherein the at least one processor is further configured to execute the NF to:
cause first Radio Resource Control (RRC) Release messages, that include the first cell reselection priority, to be sent to the group of first UEs; and
cause second RRC messages, that include the second cell reselection priority, to be sent to the group of second UEs.

13. The network device of claim 9, wherein the UE loading ratio corresponds to a specified percentage of UEs transitioning to the idle state to be assigned to each of the multiple frequency bands.

14. The network device of claim 9, wherein the multiple frequency bands comprise m frequency bands, freq_band_1, . . . , freq_band_m, wherein the UE loading ratio comprises m UE loading factor values, loading_freq_band_1, . . . , loading_freq_band_m that each comprises integer values between 1 and 9, and wherein a sum of the UE loading factor values loading_freq_band_1+ . . . +loading_freq_band_m equals 10.

15. The network device of claim 9, wherein the multiple frequency bands comprise first frequency bands, second frequency bands, and third frequency bands, and wherein the first frequency bands comprise one or more Time Division Duplexing (TDD) bands, the second frequency bands comprise one or more Frequency Division Duplexing (FDD) bands in a first frequency range, and wherein the third frequency bands comprise one or more FDD bands in a second frequency range.

16. The network device of claim 9, wherein the NF comprises a Central Unit-Control Plane (CU-CP) NF of a Radio Access Network (RAN) of the mobile network.

17. A non-transitory storage medium storing instructions executable by a network device of a mobile network, wherein execution of the instructions causes the network device to:
determine a user equipment device (UE) loading ratio among multiple frequency bands of a mobile network;
determine a first cell reselection priority, for sending to a group of first UEs transitioning to a Radio Resource Control (RRC) idle state in the mobile network, based on the determined UE loading ratio;
determine a UE loading level on each frequency band of the first cell reselection priority;
modify the UE loading ratio among the multiple frequency bands based on the determined loading level; and
determine a second cell reselection priority, for sending to a group of second UEs transitioning to the idle state in the mobile network, based on the modified UE loading ratio.

18. The non-transitory storage medium of claim 17, wherein execution of the instructions further causes the network device to:
select the group of first UEs and the group of second UEs, among multiple UEs transitioning to the RRC idle state in the mobile network, based on a service type of each of the multiple UEs, wherein the service type comprises Fixed Wireless Access (FWA) service;
cause the first cell reselection priority to be sent to the selected group of first UEs; and
cause the second cell reselection priority to be sent to the selected group of second UEs.

19. The non-transitory storage medium of claim 17, wherein the UE loading ratio corresponds to a specified percentage of UEs transitioning to the idle state to be assigned to each of the multiple frequency bands.

20. The non-transitory storage medium of claim 17, wherein the multiple frequency bands comprise m frequency bands, freq_band_1, . . . , freq_band_m, wherein the UE loading ratio comprises m UE loading factor values, loading_freq_band_1, . . . , loading_freq_band_m that each comprises integer values between 1 and 9, and wherein a sum of the UE loading factor values loading_freq_band_1+ . . . +loading_freq_band_m equals 10.
